(19) United States
(12) Patent Application Publication
(10) Pub. No.: US 2013/0117867 A1
(43) Pub. Date: May 9, 2013

(54) Theft Prevention for Networked Robot

(71) Applicant: Hei Tao Fung, Fremont, CA (US)

(72) Inventor: Hei Tao Fung, Fremont, CA (US)

(21) Appl. No.: 13/632,097

(22) Filed: Sep. 30, 2012

Related U.S. Application Data
(60) Provisional application No. 61/549,213, filed on Nov. 6, 2011.

(51) Int. Cl. G06F 21/00; G08B 13/00

(52) U.S. Cl. 726/35

(57) ABSTRACT

The robot in this invention can detect the fading or loss of wireless network signal as an indication of being removed from its working area and enter into alert mode. The purpose of robot entering into alert mode is to deter physical theft, e.g., by sounding an alarm, to protect confidential data loss, and to render the robot useless to an unauthorized person, reducing the incentives for theft. A number of techniques are employed in this invention: confidential data stored on the robot is encrypted; administrator is required to log in the robot to enable robot operations; robot is to detect abnormal conditions such as fading of wireless network signal, sudden loss of wireless network signal, loss of connectivity to management server, and physical disconnection of any computing part from itself; robot is to resume normal operations without administrator intervention when abnormal condition is rectified; an Internet management server instructs the robot to delete stored data when the robot fails to authenticate itself; and place the reset button of a computing part of the robot such that the reset button is only accessible when the computing part is physically disconnected from the robot.

### FIELD OF THE INVENTION

The present invention relates to theft prevention of a robot connected to a communication network.

### BACKGROUND

There have been many publications about theft prevention of laptops and computers in a workplace. The methods include alarms, laptop locks, and visual deterrents such as stickers or labels. Victims of laptop and computer theft can lose hardware and software and give away sensitive data and confidential information. Robots can be deployed in a workplace to perform various tasks such as inventory tracking, reception, product presentation, etc. Those robots can be considered as computers on mechanical bodies. Theft of the robots can cause the similar level of harm as laptop and computer theft. In this invention, we present a method for preventing theft of robots that are connected to a communication network in the workplace.

### SUMMARY OF THE INVENTION

The object of this invention is preventing theft of robots that are connected to a communication network in the facility where they operate.

In our preferred embodiment, the robots that benefit from this invention have capability of receiving at least one wireless network signal from a basestation. In fact, in a workplace environment, it is common to have multiple basestations covering all areas of the workplace where the robots operate. The basestations are wired to the network switches and routers so that the robots may access a management server in the local area network or one on the Internet. Consequently, the coverage area of the basestations defines the working area of the robots. When a robot is removed from its working area without a proper procedure, it is considered as a theft potentially. The robot in this invention can detect the fading or loss of wireless network signals as an indication of being removed from its working area and enter into alert mode. The purpose of robot entering into alert mode is to deter physical theft, e.g., by sounding an alarm, to protect confidential data loss, and to render the robot useless to the thieves, reducing the incentives for theft.

A number of techniques are employed in this invention: confidential data stored on the robot is encrypted; administrator is required to log in the robot to enable robot operations; robot is to detect abnormal conditions such as fading of wireless network signals, sudden loss of wireless network signals, loss of connectivity to management server, and physical disconnection of any computing part from itself; robot is to resume normal operations without administrator intervention when an abnormal condition is rectified; an Internet management server instructs the robot to delete stored data when the robot fails to authenticate itself; place the robot reset button at a concealed place.

### BRIEF DESCRIPTION OF THE DRAWINGS/FIGURES

The present invention will be understood more fully from the detailed description that follows and from the accompanying drawings, which however, should not be taken to limit the disclosed subject matter to the specific embodiments shown, but are for explanation and understanding only.

FIG. 1 illustrates a typical environment where the invention is deployed.

FIG. 2 shows an example of a robot with multiple computing parts.

FIG. 3 illustrates an embodiment of the invention disclosed.

### DETAILED DESCRIPTION OF THE INVENTION

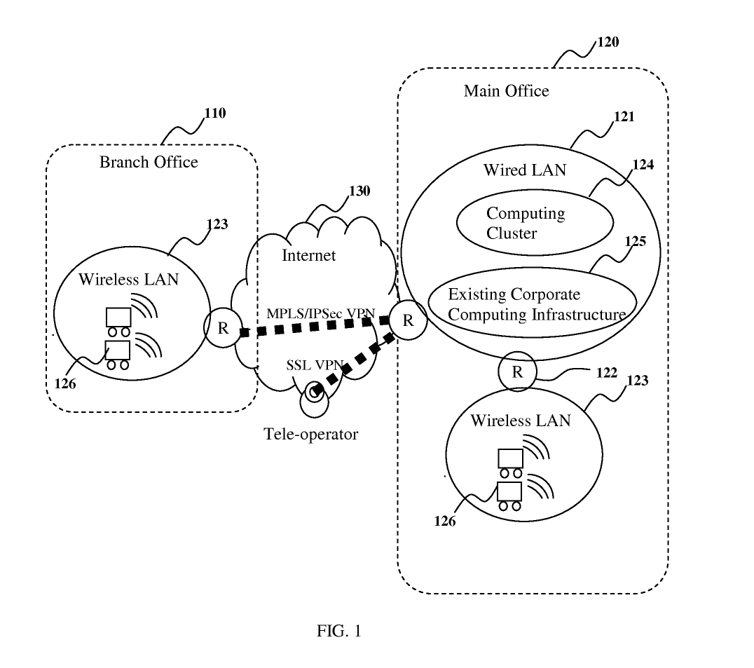

This invention is expected to be deployed in an enterprise environment similar to one depicted in FIG. 1. The enterprise may have one or more branch offices 110 in addition to its main office 120. Inside those branch and main offices, some autonomous and semi-autonomous robots 126 may be deployed, e.g., for handling office chores. Those robots 126 are connected to the corporate networking infrastructure, through wireless LAN or wired LAN and are capable of communicating to the computing cluster 124 via the corporate networking infrastructure. If some of those robots are to attain high level of mobility, then using wireless technology would make more sense. Typically, a branch office 110 is connected to the main office 120 through secure connections over the Internet 130. The main office 120 may have direct access to a corporate computing infrastructure 125, typically including data storage and computing servers. The computing cluster 124 may comprise a set of computers and robot management software developed on a distributed processing framework and run over the set of computers. The computing cluster 124 is used as a robot management server. An administrator may use the robot management software to configure and manage the robots. Although physically the same set of computers can support typical business applications, such as enterprise resource planning software, in the corporate computing infrastructure 125, we would like to make the computing cluster 124 a distinct logical entity. The computing cluster 124 handles the robot software computation in a distributed manner and maintains a knowledge database 168 in a distributed manner. The knowledge database 168 comprises data, processed or unprocessed, gathered by the office robots and a priori knowledge provided by system administrators.

The enterprise networking infrastructure assumed is typical of modern corporate network deployment and is optimal for addressing the security and computation load aspects of the robot system. The enterprise networking infrastructure may comprise wireless Local Area Networks (wireless LANs), wired Local Area Networks (wired LANs), and Virtual Private Networks (VPNs). The wireless LANs are needed as the office robots are considered to be light-duty mobile computing devices in the robot system. Robots have the ability to move around and should not be confined by wired connections. On the other hand, the computing cluster is usually on a wired LAN, i.e., the many computers in the computing cluster are connected via wired LAN. Wired LAN provides lower latency and higher bandwidth relative to wireless LAN, so wired LAN is more appropriate for the distributed processing nature of the computing cluster. When office robots and the computing cluster are co-located, they communicate via wireless LAN and wired LAN. VPNs are needed when office robots and the computing cluster are connected by the Internet, or when tele-operators' computers and the computing cluster are connected by the Internet. VPN provides secure connectivity and, in some case, service level agreement on quality of service.

In the example, the computing cluster 124 resides in the main office 120. Office robots 126 in branch offices 110 also need to access the computing cluster 124 through the Internet 130. We may deploy IPSec (Internet Protocol Security) VPN or MPLS (Multi-Protocol Label Switching) VPN between branch offices 110 and the main office 120. Then the office robots 126 in a branch office 110 communicate to the computing cluster 124 via wireless LAN 123 in the branch office 110, IPSec VPN or MPLS VPN over the Internet 130, and wired LAN 121 in the main office 120.

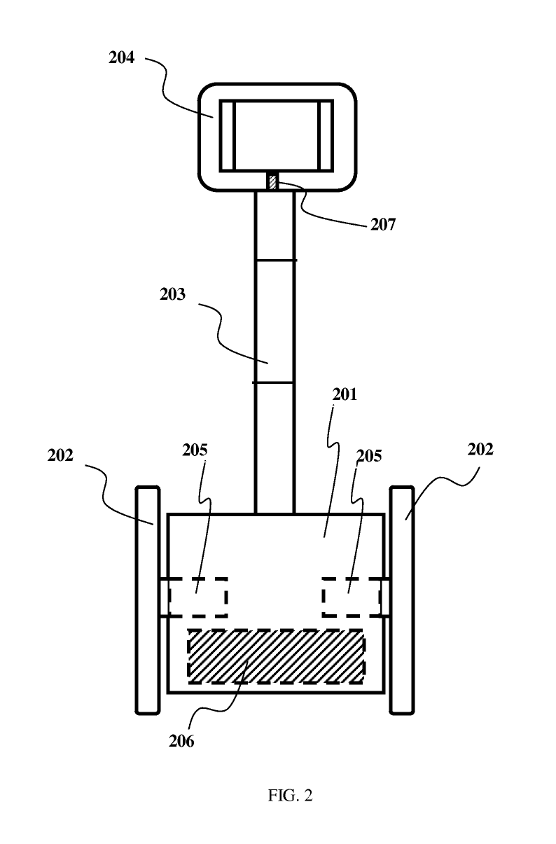

FIG. 2 illustrates an example of a robot comprising two computing parts. The robot comprises a body 201, two wheels 202, a pole 203, and a computing tablet 204. The body 201 comprises a number of motors and gears, at least one battery, and some electronics and mechanical parts. The wheels 202 are attached to the body 201 and are driven independently by motors and gears inside the body 201 so that the wheels 202 can move forward and backward independently from each other. The axes of wheels 205 are aligned on an imaginary horizontal line through the body 201, as in FIG. 2. The pole 203 is jutting out of the body 201. The purpose of the pole 203 is for upholding the computing tablet 204 that is affixed to the higher end of the pole 203 to a comfortable height for a tele-operator who controls the robot and a local user to carry out a videoconference. The computing tablet 204 comprises at least one camera, at least one speaker, at least one microphone, a screen, CPU and memory units, and a networking unit. The body 201 also houses a processor system 206. The processor system 206 controls the sensors on the robot and the motors of the wheels 202. There are electrical wires running through the pole 203. The electrical wires provide communicative connectivity between the computing tablet 204 and the processor system 206. The processor system 206 is capable of receiving control commands from the computing tablet 204 and sending sensor data to the computing tablet 204. The two computing parts of this robot are therefore the computing tablet 204 and the body 201 which houses the processor system 206. The computing tablet 204 can be physically detached from the body 203. In that case, the communicative connectivity between the computing tablet 204 and the processor system 206 is broken. A reset button 207 of the computing tablet 206 is concealed at the back the computing tablet 206. The reset button 207 is accessible only when the computing tablet 206 is physically detached from the pole 203.

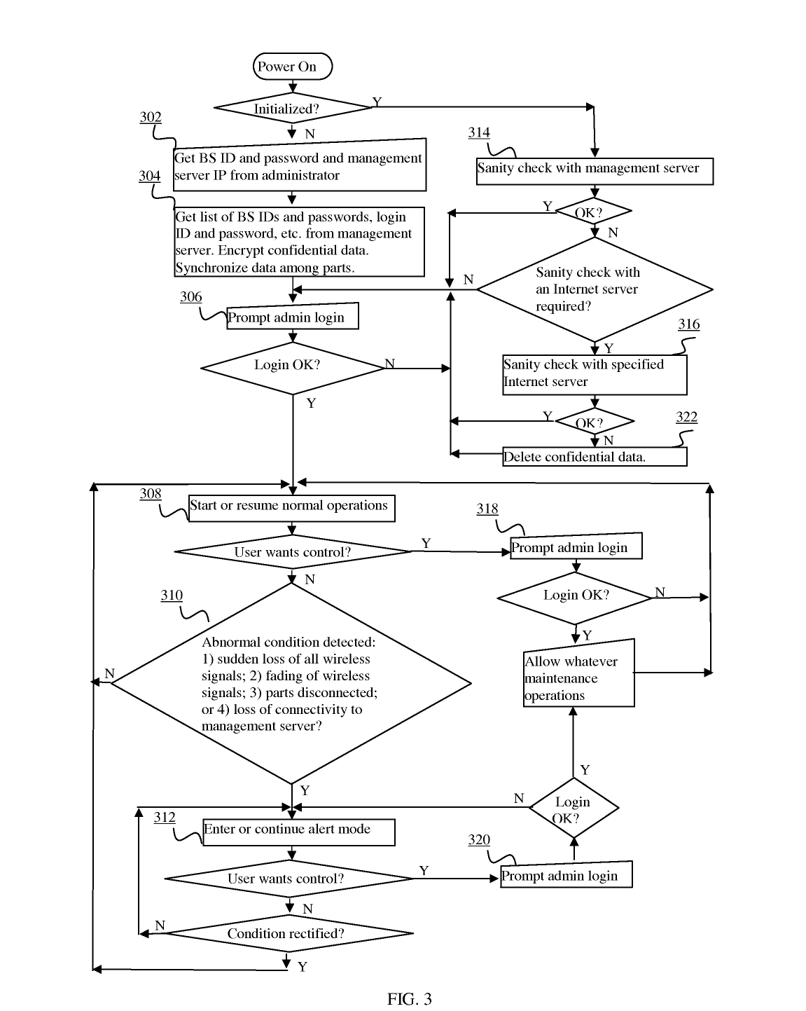

FIG. 3 illustrates an embodiment of the theft prevention method. The theft prevention method begins at the robot setup time. The robot comprises one or more computing parts. FIG. 2 shows an example. A computing part is able to perform computation, store data, and communicate with other computing parts of the robot and perhaps also with networked resources via the wireless network. The robot is to be configured before it is first used. As in step 302, an administrator needs to configure at least one basestation ID and corresponding password and at least one IP address of the management server on the robot. With one basestation ID and corresponding password, the robot is able to access the wireless network and networked resources. As in step 304, the robot is to contact the robot management server with the IP address specified. The robot is then able to receive all relevant information from the management server. Specifically, the management server may convey a list of basestation IDs and corresponding access passwords onto the robot so that the robot has access to the wireless network in its intended working area that is covered by the list of basestations. The management server may convey the robot ID and login password for the robot specified by administrator onto the robot. Also, the management server may convey onto the robot other data like applications, software upgrades, application data, etc. All confidential data including the basestation passwords and login password are encrypted on the robot. If the robot comprises multiple computing parts, then the basestation IDs and corresponding passwords, the robot ID, and the login password are synchronized among the computing parts. That is, the computing parts of the robot are bonded. After the robot setup, as in step 306, the administrator must perform a successful login on the robot to enable its normal operations. A successful login is achieved when the administrator provides a login password matching the login password stored on the robot. As in step 308, the robot performs normal operations, that is, whatever tasks the robot is supposed to do.

Once entering normal operations, as in step 310, the robot constantly detects abnormal conditions that may indicate a potential theft and enters alert mode once an abnormal condition is detected. Administrator needs to follow a proper procedure to reconfigure the robot or perform maintenance services on the robot. Administrator may use the management server to initiate many maintenance services on the robot. To administer services directly on the robot, administrator needs to log in the robot and disable the normal operations, as in step 318. Otherwise, the robot may treat the situation as a potential theft. For example, putting a computing part that has been bonded to a robot onto another robot causes the latter robot to enter alert mode because the computing parts of the robot exchange information among one another and find their data out of sync. If administrator intends to integrate the foreign computing part into the robot, administrator needs to log in the robot or log in the management server to initiate data synchronization. Then the robot may exit alert mode and resume normal operations.

The robot constantly detects abnormal conditions indicative of a potential theft. Firstly, removing a computing part from the robot is detected by monitoring the communicative connectivity among the computing parts of the robot. Similarly, a computing part being shut down or reset is detected due to loss of communicative connectivity with other computing parts of the robot. In our preferred embodiment, the communicative connectivity is achieved by electrical physical contacts among the computing parts. For example, a computing part detects an electrical signal when the computing parts are in physical contact electrically and detects loss of the electrical signal when the computing parts are no longer in contact. In order not to trigger the abnormal condition detection, administrator who wishes to remove or shut down a computing part from the robot should first log in the robot or the management server and disabled normal operations on the robot.

Secondly, removing the whole robot from its working area is detected by monitoring the fading of wireless network signal or signals to below a threshold. The fading of the wireless network signal(s) is indicative of the robot moving or being moved farther away from its working area. If the robot is autonomously moving away from its working area, then the robot should autonomously correct its path and get back into its working area. If the robot is remote-controlled to move away from its working area, then the remote control user should be warned and disallowed continuing the path. If the robot is being forcefully moved away from its working area, then the robot should enter alert mode. The latter case can be confirmed by robot failing the attempt of correcting its path autonomously.

There is the case when wireless network signal loss is due to basestation failure. That is characterized by a sudden loss of wireless network signal. When the robot is serviced by multiple basestations, loss of one wireless network signal causes little harm. When there is a sudden loss of all wireless network signals or the only wireless network signal, the robot enters alert mode. Although the condition is not indicative of a potential theft, the capability of detecting a potential theft is lost, so it is safer for the robot to enter alert mode, but it does not need to sound an alarm in this case.

A computing part of a robot sometimes may freeze due to software bugs. It is reasonable to provide a button to reset the computing part. A thief could take advantage of that fact and reset the robot before taking it away from the facility. In our preferred embodiment, we require that the reset button of a computing part should be placed at the robot body where the reset button is only physically accessible when the computing part is physically disconnected from the robot. FIG. 2 shows an example. That is, to reset a computing part on the robot, administrator must first log in and disable the normal operations on the robot; then the administrator disconnects the computing part physically from the robot to expose the reset button. If the computing part is physically disconnected from the robot while the robot is in normal operations, the computing part can detect the loss of communicative connectivity to the robot as the wired communication path is broken. Therefore, an unauthorized person is unable to reset the robot at will. The robot frozen due to software bugs can be detected by the management server as the management server is no longer receiving messages from the robot. The management server can send a notification to administrator to fix the robot quickly lest an unauthorized person would reset the robot without being detected.

When the robot enters alert mode as in step 312, it disables its normal operations. The robot may sound an alarm if its computing parts have such capability, through a speaker for example, so as to deter a potential theft to be continued. The robot may send a notification such as email to an administrator reporting the condition detected. The robot then requires an administrator login. For example, the robot displays the login screen on its computing tablet. Administrator must first log in successfully to use the robot again as in step 320.

To avoid administrator involvement every time the robot entering alert mode, the robot exits alert mode automatically when the abnormal condition that triggered the alert mode is rectified; for example, the robot is moved back to its working area, or its removed computing part is reconnected to the robot. When exiting the alert mode, the robot resumes normal operations and may send a notification to an administrator.

Suppose that a thief has successfully stolen the robot. The thief does not have the required login password, in step 306, to enable the robot for normal operations. Also, upon a robot boot-up, the robot is to contact the management server as in step 314. If the robot is unable to contact the management server, the robot is disallowed to perform normal operations. The thief could take out the storage device on the robot, but the confidential data stored are encrypted. The robot is not useful to the thief. The incentive for theft is reduced.

Furthermore, we can deploy a feature on the robot that requires the robot to contact a specific Internet server at robot boot-up. Suppose that a theft of the robot has been reported. When a stolen robot tries to contact the Internet server as in step 316, the Internet server can fail the authentication of the robot and record the IP address of the robot and the network routes taken to reach the robot. The robot failing the authentication is disallowed to perform normal operations. The Internet server may further instruct the robot to delete its stored data as in step 322. Also, the Internet server may report the failed authentication instance to law enforcement to track down the stolen robot.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method for preventing theft of a robot connected to a management server via a wireless network, the method comprising the steps, executed in a processor of the robot, of:
encrypting confidential data stored on said robot;
requiring successful login to enable normal operations of said robot; and
entering alert mode when detecting abnormal conditions.

2. The method as in claim 1, wherein said robot receive one or more wireless network signals from one or more basestations in said wireless network.

3. The method as in claim 2, wherein said confidential data comprise access passwords of said one or more basestations.

4. The method as in claim 2, wherein said abnormal conditions comprise fading of all of said one or more wireless network signals to below a threshold.

5. The method as in claim 2, wherein said abnormal conditions comprise a sudden loss of all of said one or more wireless network signals.

6. The method as in claim 1, wherein said abnormal conditions comprise loss of network connectivity to said management server.

7. The method as in claim 1, wherein said robot comprises a plurality of computing parts having communicative connectivity to each other.

8. The method as in claim 7, wherein said abnormal conditions comprise a loss of said communicative connectivity to one of said plurality of computing parts from said robot.

9. The method as in claim 7, wherein a reset button of said robot is located on said robot where said reset button is only physically accessible when a computing part, of said plurality of computing parts, is physically disconnected from said robot.

10. The method as in claim 1, wherein said entering alert mode comprises disabling said normal operations.

11. The method as in claim 1, wherein said entering alert mode comprises sounding an alarm of said robot.

12. The method as in claim 1, wherein said entering alert mode comprises sending a notification to an administrator of said robot.

13. The method as in claim 1, wherein said entering alert mode comprises requiring successful login before resuming said normal operations.

14. The method as in claim 1, further comprising the step of resuming said normal operations automatically when said abnormal conditions that caused said robot to enter said alert mode are rectified.

15. The method as in claim 1, further comprising the step of requiring successful login to resume said normal operations when having entered in said alert mode.

16. The method as in claim 1, further comprising the step of requiring successful login to disable said normal operations when having enabled said normal operations.

17. The method as in claim 1, wherein said robot deletes said confidential data when failing a sanity check of a specified server on Internet.

18. The method as in claim 17, wherein said specified server on Internet records an IP address of said robot and network routes to reach said robot.

19. A robot comprising:
a plurality of computing parts having communicative connectivity to each other, wherein one computing part, of said plurality of computing parts, disables normal operations of said robot when detecting a loss of said communicative connectivity to another computing part, of said plurality of computing parts; and
a reset button, located on said robot, wherein said reset button is only physically accessible when said one computing part, of said plurality of computing parts, is physically disconnected from said another computing part, of said plurality of computing parts.
